(19) United States
(12) Patent Application Publication
(10) Pub. No.: US 2005/0102372 A1
(43) Pub. Date: May 12, 2005

(54) File transfer system

(76) Inventor: Sandeep Betarbet, Lilburn, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/706,396

(22) Filed: Nov. 12, 2003

(51) Int. Cl. G06F 15/16

(52) U.S. Cl. 709/217

(57) ABSTRACT

A file transfer system is provided that typically includes an originating file transfer host that includes a script server and an originating file transfer server. The script server typically receives a file and a script from a remote terminal, interprets the script, and transfers the script and the file to the originating file transfer server. The originating file transfer server receives the script and the file from the script server and transfers the file to a terminating file transfer server in accordance with the script. Methods and other systems are also provided.

### TECHNICAL FIELD

The present disclosure is generally related to telecommunications and more particularly to file transfer over a network.

### DESCRIPTION OF THE RELATED ART

Businesses have been increasingly dependent upon the ability to quickly and easily transfer information between various units. These units can be separated both physically by long distances, and conceptually by servers and firewalls. Over the last few decades several technologies have developed in an effort to span this separation.

Among the first efforts to transfer information quickly and easily was File Transfer Protocol (FTP). FTP typically works by invoking an FTP client from a terminal and specifying a terminal from which (or to which) the user would like the file transferred. However, FTP does not provide reliable and secure file transfers. For at least these reasons, Sterling Commerce, Inc. of Dublin, Ohio developed a software package called Connect:Direct.

Connect:Direct is peer-to-peer file-based software which is typically used for transferring large amounts of data securely between hosts. Files can be transferred from a host running an originating Connect:Direct server by a local ConnectDirect user. A local ConnectDirect user is a user having a login account at the host which is registered with the Connect:Direct server. The file transfer can be made to a remote host running a terminating Connect:Direct server. The file can be received on the terminating Connect:Direct Server by a local ConnectDirect user.

A shared host running an originating Connect:Direct server is used for typical file transfers. The file and the script either exist on the shared host or are copied to it by other means by a user with a login account at the shared host. For example, the file and a script can be copied to the shared host with a login account via FTP. A local Connect:Direct user opens up a terminal on the shared host and instructs the Connect:Direct server to transfer the file to a terminating Connect:Direct server operating on a remote host machine using the script.

The originating Connect:Direct server (with the license) is typically dedicated to a single process/application transferring files to the terminating Connect:Direct server. Further, the number of local ConnectDirect users (i.e. host login accounts registered with ConnectDirect server) is limited. Thus, companies typically purchase multiple ConnectDirect Server licenses for each host and/or application and tightly control the number of local Connect:Direct users and strongly couple them to individual applications because of the expense of the licenses and support for system. Therefore, there is a need for systems and method that address these and/or other perceived shortcomings of the prior art.

### SUMMARY OF THE DISCLOSURE

One embodiment, among others, of the present disclosure provides for a file transfer system. A representative system, among others, includes a host server having a script server and an originating server. The script server can receive a file and a script associated with the file from at least one remote terminal, interpret the script, and transfer the script and the file to an originating file transfer server. The originating file transfer server typically receives the script and the file from the script server and transfers the file to a terminating file transfer server in accordance with the script.

An embodiment of the present disclosure provides methods for file transfer. A representative method, among others, can include the following steps: receiving a script and at least one file associated with the script at a script server of a host; communicating said at least one file to a originating file transfer server of a host; and, transferring said at least one file to a terminating file transfer server in accordance with the script associated with said at least one file.

Other systems, methods, and/or computer programs products according to embodiments will be or become apparent to one with skill in the art upon review of the following drawings and detailed description. It is intended that all such additional system, methods, and/or computer program products be included within this description, be within the scope of the present disclosure, and be protected by the accompanying claims.

### BRIEF DESCRIPTION OF THE DRAWINGS

The disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a block diagram illustrating a previous system using a Connect:Direct software package.

FIG. 1B is a block diagram illustrating the configuration of the Connect:Direct host computer shown in FIG. 1A.

FIG. 2 is a block diagram of an embodiment, among others, integrating the present disclosure into the system of FIG. 1A.

FIG. 3 is a block diagram of an embodiment, among others, integrating the present disclosure into the system of FIG. 1A.

FIG. 4 is a block diagram of an embodiment, among others, integrating embodiments of FIGS. 2 and 3.

FIG. 5 is a flowchart illustrating the operation of an embodiment, among others, of the system shown in FIGS. 2 and 4.

FIG. 6 is a flowchart illustrating the operation of an embodiment, among others, of the system shown in FIGS. 3 and 4.

### DETAILED DESCRIPTION OF THE PREFERRED EMBODIMENTS

The disclosure now will be described more fully with reference to the accompanying drawings. The disclosure may, however, be embodied in many different forms and should not be construed as limited to the embodiments set forth herein; rather, these embodiments are intended to convey the scope of the disclosure to those skilled in the art. Furthermore, all “examples” given herein are intended to be non-limiting.

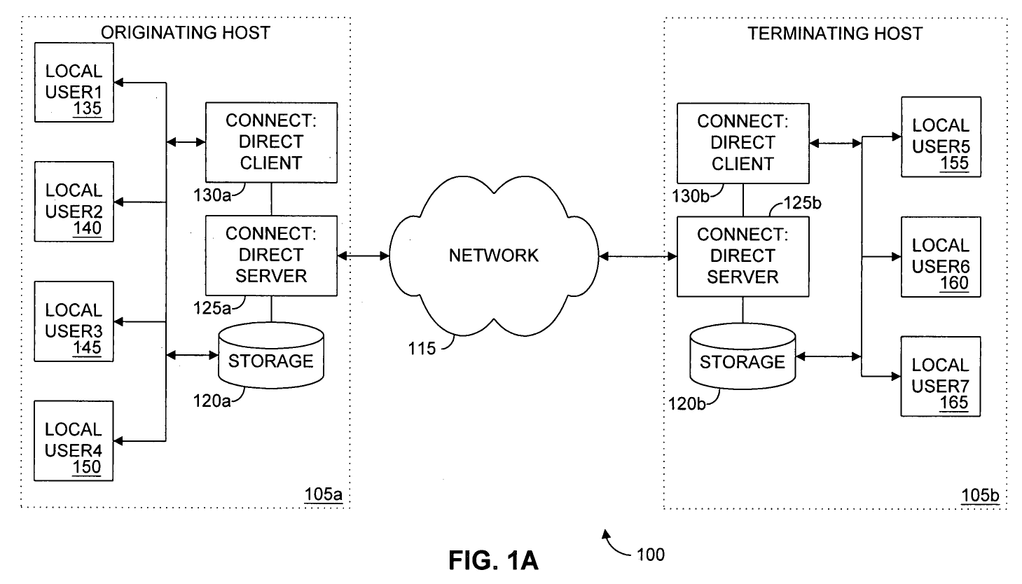

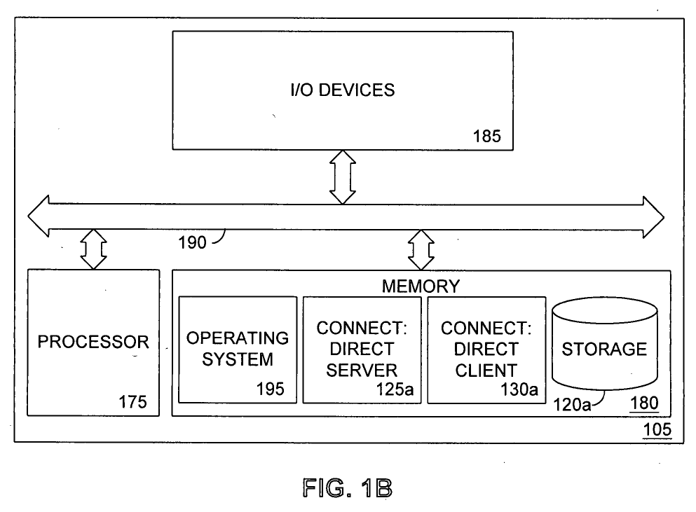

Referring to FIG. 1A, shown is an embodiment, among others, of a typical system 100 using conventional file transfer software, such as Connect:Direct. Typically, because Connect:Direct licenses are relatively expensive, they are not installed on every computer in a group. Instead, the Connect:Direct software is installed on host computers 105. The host computers 105 are typically connected by a network 115. The network 115 can be an intranet or the internet, among others. One skilled in the art should also recognize that the network 115 could also be two or more intranets connected through an extranet.

Typically, each host 105 includes a database 120 for storing information, a Connect:Direct server application 125 and a Connect:Direct client application 130. The host computers 105 also each typically host several local users 135-165. The local users 135-165 typically access the host computers 105 via a remote terminal (not shown) such as an employee computers, which can contain a plethora of information, such as, for example, billing and customer information. One skilled in the art should recognize that there are often internal networks connecting remote hosts/terminals to the local user accounts 135-150, 155-165.

In one common scenario, a person associated with the user1 account 135 on the originating host 105a may have several files (not shown) that need to be transferred to a user coupled to the terminating host 105b. In one embodiment, among others, these files may be billing records for a company. In order to accomplish the bulk transfer of files, the person associated with the user1 account 135 transfers the files to the originating (or local) host 105a. This file transfer is typically accomplished by using network drives, FTP, gopher, or any other suitable file transfer protocol known to those skilled in the art. Upon transferring the files to a database 120a at the originating host computer 105a, the person typically opens a remote terminal connection to the local account 135 at the host computer 105a. As known to those skilled in the art, the remote connection allows a user to access host functions, applications and processing power from a remote terminal (not shown) in lieu of being physically present at the host computer 105a.

After opening a remote terminal connection to the originating host computer 105a, the user typically launches the Connect:Direct client 130a by typing in a command line associated with the software, or by selecting an icon representation associated with the software, depending on the operating system of the host computer. The Connect:Direct client 130a allows the user to invoke the Connect:Direct server 125a in order to transfer the files previously uploaded onto the originating host 105a to a terminating host 105b having Connect:Direct software.

The Connect:Direct file transfer server 125a typically sends a file transfer message (not shown), which includes filename(s) and local user(s) (recipient(s)), to the terminating host Connect:Direct file transfer server 125b to make the server aware that a file is being transferred. The terminating host 105b then typically receives the files with a Connect:Direct file transfer server 125b. The Connect:Direct file transfer server 125b uses a preference list to determine a database 120b directory associated with the local user recipient named in the file transfer message. Typically the directory will be a home directory of the local user recipient, however, the local user recipient can specify another location (via the preference list) in which the file can be saved on the host system 105b database 120b.

Once the file is saved at the host system 105b database 120b, a user to which the file was sent was required to retrieve the file from the database 120b. If the file was not retrieved, and another file with the same name arrived at the terminating host 105b, the Connect:Direct file transfer server 125b would read the file transfer message to determine whether the original file should be overwritten. As one skilled in the art should recognize, a variable called “disposition” can be set in the Connect:Direct software. If this variable is set to “new”, the file will be bounced back to the originating file transfer server 125a by the terminating file transfer server 125b. However, if the disposition variable is set to “rpl” (replace), the terminating file transfer server 125b will overwrite the older file with the newer file. Employees are often not aware of this disposition variable, thus, the variable is usually set to the default value, “new”. This creates problems because the sender may not understand why the file cannot be transferred, and may assume that there is something wrong with the receiving system. Moreover, even if the person knew about the disposition variable, setting the value to “rpl” might replace a file that has not yet been retrieved by the receiving user. Previously users have been required to retrieve transferred files using such protocols as FTP, gopher, etc. This is time consuming and can create a bottleneck at the terminating host 105b.

Referring now to FIG. 1B, shown is a generic block diagram of the host computer 105a (and 105b) of FIG. 1A. Generally, in terms of hardware architecture, as shown in FIG. 1B, the host computer 105a includes a processor 175, memory 180, and one or more input and/or output (I/O) devices 185 (or peripherals) that are communicatively coupled via a local interface 190. The local interface 190 can be, for example but not limited to, one or more buses or other wired or wireless connections, as is known in the art. The local interface 190 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 175 is a hardware device for executing software, particularly that stored in memory 180. The processor 175 can be any custom made or commercially available processor, a central processing unit (CPU), an auxiliary processor among several processors associated with the host computer 105a, a semiconductor based microprocessor (in the form of a microchip or chip set), a macroprocessor, or generally any device for executing software instructions.

The memory 180 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 180 may incorporate electronic, magnetic, optical, and/or other types of storage media. Note that the memory 180 can have a distributed architecture, where various components are situated remote from one another, but can be accessed by the processor 180.

The software in memory 180 may include one or more separate programs 130a, 125a, 195, each of which comprises an ordered listing of executable instructions for implementing logical functions. In the example of FIG. 1A, the software in the memory 180 includes the Connect:Direct server and Connect:Direct client systems and a suitable operating system (O/S) 195. A nonexhaustive list of examples of suitable commercially available operating systems 195 is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., PalmOS available from Palm Computing, Inc., and Windows CE available from Microsoft Corporation). The operating system 195 essentially controls the execution of other computer programs, such as the Connect:Direct server and Connect:Direct client systems 125a, 130a, and provides scheduling, input-output control, file and data management, memory management, and communication control and related services.

The Connect:Direct server and Connect:Direct client systems 125a, 130a are source programs, executable program (object code), script, or any other entity comprising a set of instructions to be performed. When a source program, then the program needs to be translated via a compiler, assembler, interpreter, or the like, which may or may not be included within the memory 180, so as to operate properly in connection with the O/S 195. Furthermore, the Connect:Direct server and Connect:Direct client systems 125a, 130a can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 185 may include input devices, for example but not limited to, a keyboard, mouse, scanner, microphone, etc. Furthermore, the I/O devices 185 may also include output devices, for example but not limited to, a printer, display, etc. Finally, the I/O devices 185 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the host computer 105a is a PC, workstation, or the like, the software in the memory 180 may further include a basic input output system (BIOS) (omitted for simplicity). The BIOS is a set of essential software routines that initialize and test hardware at startup, start the O/S 195, and support the transfer of data among the hardware devices. The BIOS is stored in ROM so that the BIOS can be executed when the host computer 105a is activated.

When the host computer 105a is in operation, the processor 175 is configured to execute software stored within the memory 180, to communicate data to and from the memory 180, and to generally control operations of the host computer 105a pursuant to the software. The Connect:Direct server and Connect:Direct client systems 125a, 130a and the O/S 195, in whole or in part, but typically the latter, are read by the processor 175, perhaps buffered within the processor 175, and then executed.

When the Connect:Direct server and Connect:Direct client systems 125a, 130a is implemented in software, as is shown in FIG. 1B, it should be noted that the Connect:Direct server and Connect:Direct client systems 125a, 130a can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The Connect:Direct server and Connect:Direct client systems 125a, 130a can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

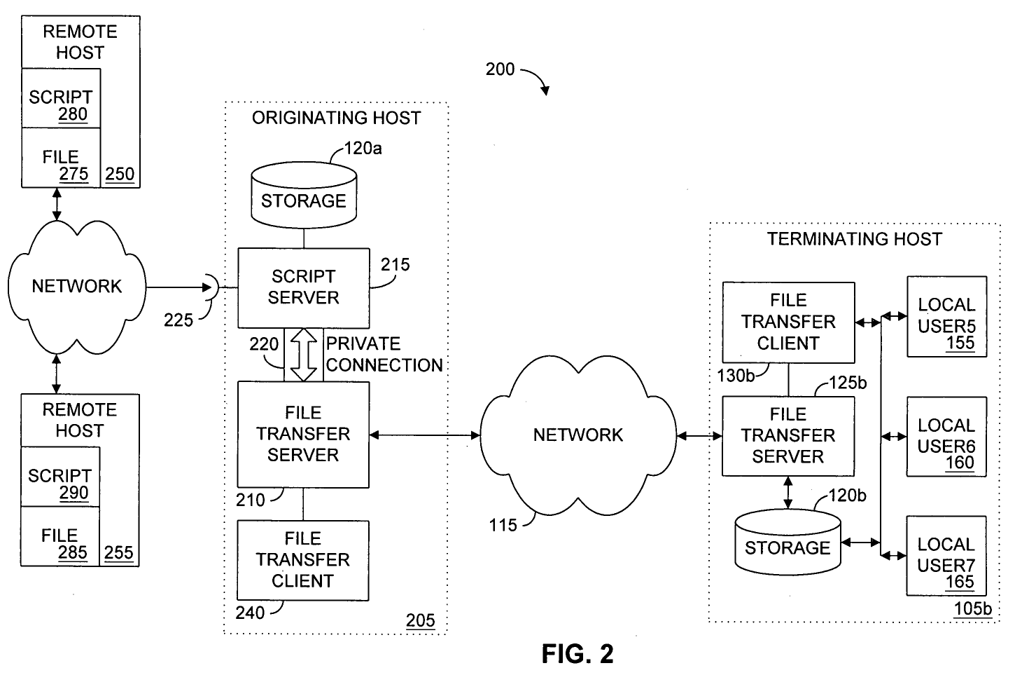

Referring now to FIG. 2, shown is an embodiment, among others, of the present disclosure. The system 200 typically includes a similar network structure to that of FIG. 1A, and the host 205 hardware and O/S is identical to that described in FIG. 1B. In addition to the file transfer software, such as Connect:Direct, the system 200 also typically includes an application for a script server as described below. In an embodiment, among others, the network 115, the terminating file transfer host 105b, and each of the remote terminals 155-165 work substantially identically to the terminating host in of FIGS. 1A and 1B. The originating host 205 in an embodiment, among others, includes a Connect:Direct file transfer server program 210 (hereinafter file transfer server, which differs from the Connect:Direct Server 125 of FIG. 1A by an additional interface 220), a script server program 215 (hereinafter script server), and a private connection 220 between the file transfer server 210 and the script server 215. It should be appreciated with respect to the script server 215, storage 120a, file transfer server 210 and file transfer client 240, that these programs typically reside in the memory 180 of the host computer 205, as explained with respect to FIG. 1B.

The script server 215 typically monitors a port 225 of the host computer 205. One skilled in the art should recognize that multiple file transfers can be substantially simultaneously received by the script server 215. Typically, when an initial connection is made from a remote host 250, 255, a new process is triggered to handle the transfer of data, such that the script server can continue to monitor the port 225 for any other initial connections to the host computer 205. Each additional initial connection typically triggers its own process to effect the transfer of data. The script server 215 is typically connected to the file transfer server 210 by a private connection 220. The private connection allows transmission of the file transfers at the file transfer server without the invocation of the file transfer client 240.

The remote hosts 250, 255 are typically computers, and in one embodiment, among others, of the present disclosure includes a Java application installed on the remote hosts 250, 255 enabling the remote hosts 250, 255 to communicate files 275 and scripts 280 to the originating host computer 205 script server 215, and receive a tracking number from the originating host computer 205. The tracking number is typically used to query the file transfer server 210 to trace the steps of the file transfer process executed by the file transfer server 210. As those skilled in the art should recognize, Java is a platform independent object-oriented programming language used to develop enterprise applications. The script 280 is typically a small file that describes to the script server what to do with the file. In other words, it provides a title for the script process, identifies the filename, and tells the scripts server that the files should be copied from a primary node (originating host) to a secondary node (terminating host). The application typically provides an interface enabling the user to send a file 275 and a script 280 to the originating host computer 205, trigger the server 210 to transfer the file, and return a tracking number.

It should be recognized that the application typically includes a listing of the ports at any particular host 205 that are available for use, and automatically determines which port to use. One skilled in the art should also recognize that other kinds of file transfer applications that require the instantiation of a client to use a file transfer server software are also included within the scope of various embodiments, among others, of the present disclosure.

Upon a remote terminal 250 sending a file 275 and a script 280 to the host computer 205 using the remote terminal application (not shown), the script server 215 would detect an incoming file transfer. The script server 215 typically stores the incoming information to storage 120a. Upon completion of receipt of the file 275 and script 280, the script server 215 typically submits the file with the proper instructions to the file transfer server 210 via a private connection 220, bypassing the file transfer client 240.

The file transfer server 210 typically adds the submitted file to a transfer queue in storage 120a and returns control back to the script server 215 after a delay specified in the script. Upon returning control, the file transfer server 210 passes a tracking number back to the script server 215. The script server 215 logs the tracking number and name of the submitted file to its own record (a script server log). The script server 215 in turn passes the tracking number back to the remote terminal that initiated the file transfer. The file transfer server (which typically constantly polls the transfer queue) executes the transfer of any files in the transfer queue. If the file transfer server is unable to transfer the file it is moved into a hold queue until the transfer can be executed. The file transfer typically begins with the originating host 205 sending a file transfer message to the terminating host 105b.

In an alternative embodiment, the remote host 250, 255 has another connection through an application (connected to the script server 215) to track the progress of a previous file submitted for transfer. The remote host 250, 255 typically sends a tracking number (obtained from a previous file transfer action) to the script server 215. The script server 215 queries the file transfer server 210 and receives all the records documenting the various actions executed in transferring the file.

At the terminating host 105b, the terminating host computer 105b would typically first receive a file transfer message alerting the terminating host 105b of a file transfer session. The file transfer message (not shown) typically includes a filename (or filenames, if multiple files are being transferred) and a recipient user account to whom the files are being transferred. Typically, the terminating host computer 105b then stores the transferred file(s) in a home directory (not shown) associated with the recipient's local user account identified in the file transfer message, using the filename(s) identified in the file transfer message. The recipient would then be required to retrieve the file using his or her local user account 155-165. The user would typically access his or her local user account 155-165 using a remote host (not shown).

The script server, in one implementation, includes another application which is used to clean up files that have been successfully transferred by the originating file transfer server 210. A remote host 250, 255 typically sends a token string as a command to the script server 215. The command triggers the script server 215 to examine the script server log. Using the tracking number and filename documented for each submitted file, the script server 215 examines the status of submitted files from the transfer queue of the file transfer server 210. All submitted files which have been successfully transferred, are deleted.

One skilled in the art should understand that the host computer 205 can also continue to operate using the file transfer client 130a. Thus, the host computer 205 is able to operate as described with respect to FIG. 1A, though the host computer 205 now also includes the functionality to allow remote hosts to transfer files and scripts without a local presence.

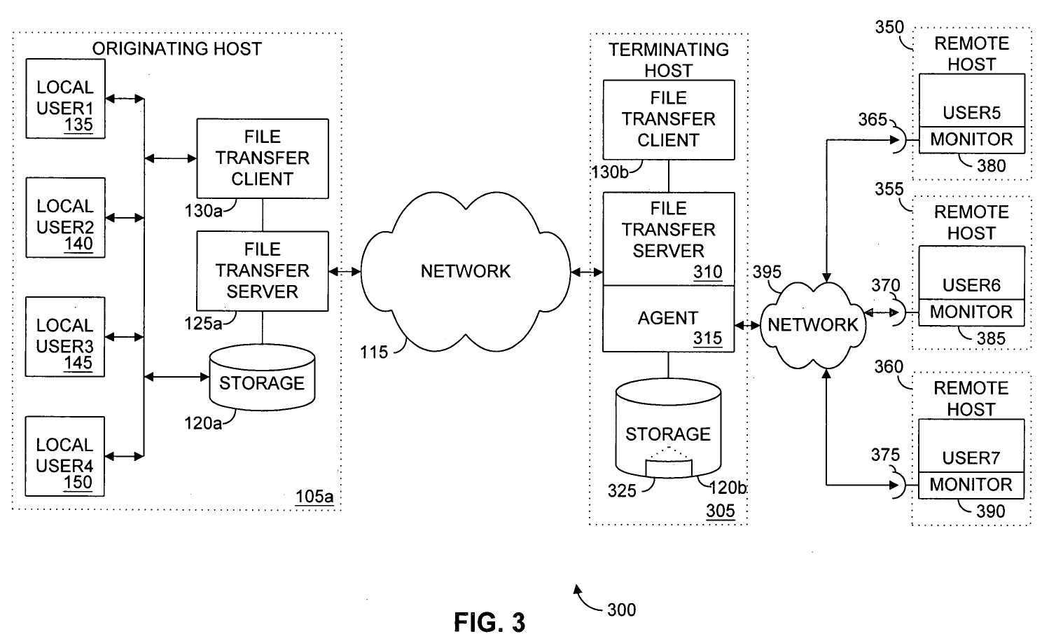

Referring now to FIG. 3, shown is an alternative embodiment, among others, of the present disclosure. A system 300 typically includes a network structure substantially similar to that shown in FIG. 1A. In this embodiment, among others, the originating host 105a, the local user accounts 135-150, and the network 115 operate substantially identical to the originating host 105a of FIG. 1A. The terminating host 305 in an embodiment, among others, includes a Connect:Direct file transfer server 310 (also referred to as a file transfer server), an agent program 315 (hereinafter agent), and a database 120b.

The file transfer server 310 typically operates substantially similar to the Connect:Direct file transfer server 125b of FIG. 1A in receiving files from an originating host 105a. However, when the file transfer server 310 receives a transfer file message (not shown), the file transfer server 310 launches an agent 315. Again, the file transfer message typically includes a filename (or filenames) being transferred and a local user to which the file(s) are being transferred. The agent 315 manages the transfer of the file(s) through the file transfer server, and stores the file transfer in a home directory associated with the local user identified in the file transfer message.

The agent 315 further retrieves a configuration file 325 from the home directory associated with the local user identified in the file transfer message. In one example, the configuration file 325 typically is a “<filename>.cfg” file, where <filename> is the name of the local user. Moreover the configuration file 325, in one embodiment, among others, includes a remote host name and a port number associated with the remote host name. As those skilled in the art should recognize the remote host name identifies a remote host 350-360 on a network 395, and the port number 365-375 identifies a particular port on that remote terminal. The agent reads the configuration file 325 to determine what host name and port number are identified by the local user as a home terminal. Once the agent has determined the host name and port number associated with the configuration file 325, the agent transfers the file to the remote host 350-360. In alternative embodiments, among others, of the present disclosure, the configuration file 325 specifies that the file be deleted from the home directory of the local user after it is transferred to the host name and port number specified by the configuration file 325. This enables a sender to make multiple transfers having the same filename without having the transfer rejected by the file lo transfer server 125b, and allows the recipient to prevent files from being overwritten before he or she has a chance to review the transferred files.

The remote terminal 350-360 will typically receive the file through a monitor application 380-390 running in the background on the remote terminal 350-360. The monitor application 380-390 can be a Java program used to monitor the port number specified by the local user in his or her configuration file 325. The remote terminal further includes a file processor (not shown) which receives the filename(s) of the received file(s), and matches the filename(s) to the file(s) and stores the processed file in a transfer directory on the remote terminal 350-360.

One skilled in the art should recognize that this addition to the terminating host computer 305 and remote hosts 350-360 allows a user to receive files in real time. Moreover, the file processor can be configured to prevent the user from losing transferred files because of overwriting. Further, many users from multiple groups could share the Connect:Direct node license without any particular group receiving the brunt of the cost of the Connect:Direct license.

One skilled in the art should also understand that the host computer 305 is able to continue to interact with local users not using the remote functionality of the present disclosure. Thus, the terminating host computer 305 is able to operate as described with respect to FIG. 1A, though the host computer 305 also includes the functionality to allow remote hosts 350-360 to receive files without necessitating a local presence on the terminating host computer 305.

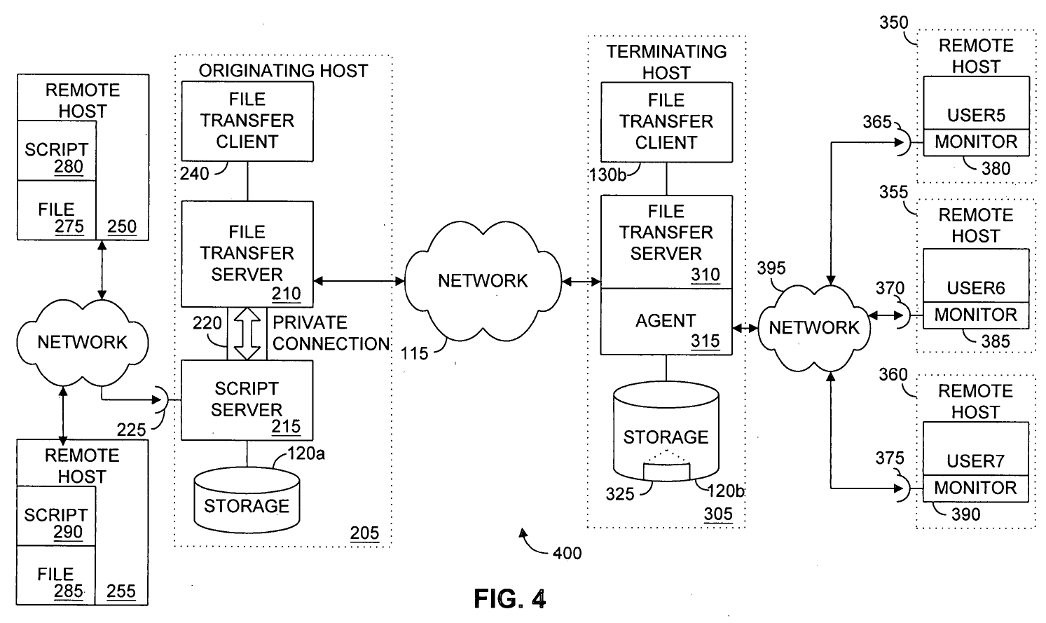

Referring now to FIG. 4, shown is an alternative embodiment, among others, of the present disclosure. The architecture of a system 400 is a combination of the architectures of the systems of FIGS. 2 and 3 (200 and 300, respectively). In this embodiment, among others, of the present disclosure, a user who wishes to transfer a file (or files) to a second user would use a file transfer application located on a computer 250.

The user typically creates a script on the computer 250 and uses a file transfer application to send the file(s) and script to a script server 215 located at an originating host 205. In one implementation, the file transfer application includes a graphical user interface (GUI), enabling the user to easily navigate the process of uploading the script and file(s) to the originating host 205. Moreover, one skilled in the art should recognize that, in some implementations, the creation of the script is automated such that a wizard type program creates the script for the user. This wizard-type application lessens the chance for errors in writing the script and enables even novice users the full power of each of the available variables used in the transfer script. It should be recognized that the above implementations also apply to the embodiment described with respect to FIG. 2.

The script server 215 typically stores the file(s) in storage 120a. The script server 215 then communicates the file(s) to a file transfer server 210 on a private connection 220, bypassing the file transfer client 240. The file transfer server 210 at the originating host 205 typically transfers the file(s) to a file transfer server 310 at a terminating host 305 via a network 115. This is typically done by sending a file transfer message from the originating host file transfer server 210 to the file transfer server 310 at the terminating host 305 and then transferring the file(s). As described above, the file transfer message typically includes filename(s) and local user account(s) to whom the file(s) are being transferred.

The file transfer server 310 at the terminating host typically receives the file transfer message, and executes an agent 315. The agent 315 determines a home directory associated with the local user identified in the message, and directs the transfer of the file(s) to the home directory residing in a database 120b at the terminating host 305. After saving a file to the home directory, the agent 315 reads a configuration file 325 located in the home directory to determine where the file should be sent. Upon determining a remote host name and port number to which the local user has requested that file transfers be directed, the agent 315 then streams the file(s) and filename(s) to the remote host computers 350-360 ports 365-375, respectively. After sending the file(s) and filename(s), in some implementations, the agent is configured to delete the file(s) from the home directory based upon settings made in the configuration file.

The remote host computer 350-360 typically includes a monitor program 380-390. The monitor program 380-390 typically monitors the port 365-375, respectively, for incoming communications from the agent 315. Upon sensing that a file is being transferred to the computer 350-360 the monitor program 380-390 accepts the incoming stream from the terminating host 305. The incoming stream typically includes the file(s) and filename(s). The monitor program 380-390 then calls a file processor (not shown) to process the file(s) and filename(s) received. Typically the file processor parses/processes the file(s) and filename(s) and stores them for later retrieval by the recipient from the a storage structure (not shown) located at the computer 360-370.

In an alternative embodiment, among others, an alert is added to the monitor process running on the remote host computer 360-370. This alert is typically triggered by the completion of a file transfer streamed to the remote host computer 360-370, and alerts the user to the presence of the new file just transferred to his/her computer. The alert in some embodiments, can take the form of a pop-up window, an 10 e-mail message, a tray icon, etc. One skilled in the art should understand, however, that this embodiment, among others, of the present disclosure is not intended to be limited to a particular type of alert. Instead, it is intended that the alert could be provided through any of a plethora of input/output (I/O) devices.

Moreover, one skilled in the art should recognize that host computers 205, 305 are typically interchangeable. For example, the file transfer server 210 at host 205 could include an agent for terminating file transfers, and the host 305 could include a script server for originating file transfers. Thus, each host 205, 305 would be able to originate file transfers and terminate file transfers, providing symmetry to the architecture. Therefore, each remote terminal could also be able to originate and terminate file transfers using the various embodiments, among others, of the present disclosure.

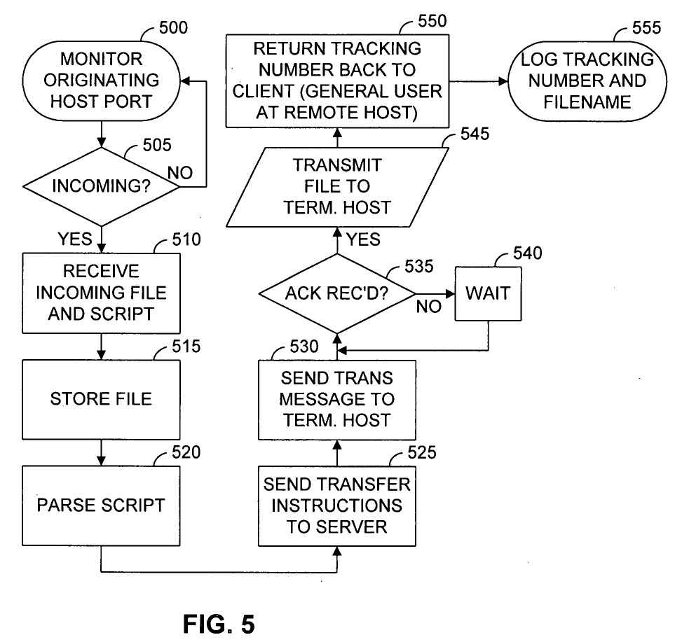

Referring now to FIG. 5, shown is a flowchart illustrating a process used for receiving transfer requests at originating host 205 from remote terminals 250, 255. In accordance with step 500, the process typically monitors the incoming file transfer port 225 for incoming scripts and files from an application (not shown) on a remote host 250, 255. At step 505, the script server 215 determines whether an incoming file transfer request has been received by incoming file transfer port 225. If there has been no incoming file transfer request, the script server returns to monitoring the port 225 in accordance with step 500.

However, if there is an incoming file transfer request, at step 510, the script server 215 receives the file(s) 275 and the script 280 associated with the file(s) 275. At step 515, the script server 215 typically stores the file(s) 275 in storage 120a. The script server 215 parses the script 280 in step 520. The script server then sends the transfer instructions, similarly to 130a (FIG. 1A), from the parsed script directly to the file transfer server 210 on a private connection 220 in step 525, bypassing the file transfer client 130a. In step 530, the file transfer server 210 typically sends a file transfer message to the terminating host 305. The file transfer server 210 then listens for an acknowledgment of the file transfer message in step 535. If no acknowledgment is received, the file transfer server 210 typically waits for a period of time as shown in step 540, and then checks to determine if an acknowledgment has been received in step 535.

If an acknowledgment is received, the file transfer server 210 proceeds in transferring the file to the terminating host 305 in step 545. The file transfer in some embodiments, among others, of the present disclosure occurs using a Connect:Direct protocol. Upon completion of the file transfer, the script server 215 typically sends a tracking number back to the user at the remote host 250, 255 in accordance with step 550.

In some embodiments, among others, the script server 215 removes the file(s) from storage 120a of the originating host 205. In order to remove the file(s) from storage 120a, the script server 215, upon submission of the file to the file transfer server 210, typically makes an entry into its log as shown in step 555. The entry consists of the tracking number received from the file transfer server 210 and the name of the file forwarded to the file transfer server 210. This log is typically used in a clean-up application. The script server 215 upon receipt of a “clean” command from a remote host 250, 255, traverses each of the entries in the log using the tracking number of each entry it queries from the file transfer server 210 to ascertain the status of the file submitted for transfer. Upon receiving a status corresponding to “success”, it deletes the submitted file from the storage database.

The script server 215 also typically includes an application to return messages that document the progress of the file submitted for transfer. The remote host 250, 255 typically passes a tracking number of a previously submitted file, and the script server 215 queries the file transfer server 210 to obtain each of the messages recorded during execution of the steps in the file transfer. These messages are then returned to the remote host 250, 255.

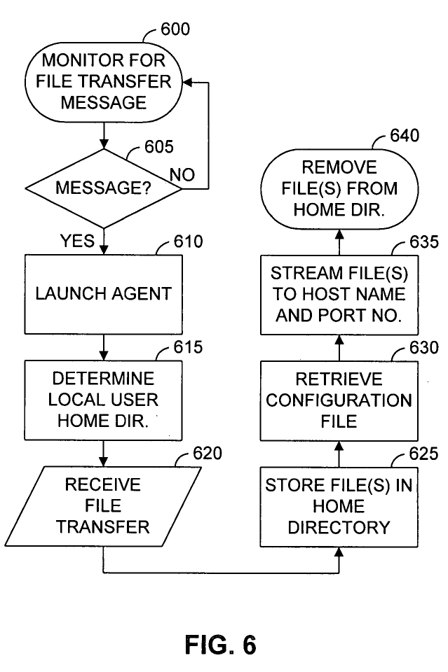

Referring now to FIG. 6, shown is a flowchart illustrating a process used for handling files to be distributed by the terminating host computer 305 to terminating computers 350-360. The file transfer server 310 typically waits for a file transfer message to be received as shown in step 600. In step 605, the file transfer server 310 checks to determine whether a file transfer message has been received. If no file transfer message has been received, the file transfer server 310 returns to step 600.

However, if a file transfer message is received, the file transfer server 310 launches an agent program 315 in step 610. The agent program 315 typically reads the file transfer message to determine a local user account associated with the message, and a home directory associated with the local user account, as shown in step 615. The agent program 315 then directs the file transfer to the home directory, in accordance with step 620. The file transfer typically is performed via the file transfer server 310 and the network 395. Shown in step 625, the agent program 315 stores the file(s) in the home directory associated with the local user. After the file transfer is complete, the agent program 315 typically retrieves a configuration file 325 from the home directory associated with the local user account, as shown in step 630. The configuration file 325 typically includes a remote host name and a port number of a remote host computer 350-360 associated with the local user. Upon determining this information, the agent program 315 streams the files to the remote host name and port number identified in the home directory of the local user account, as shown in step 635. Upon completing the file transfer, the agent program 315 removes the files from the home directory of the local user account. One skilled in the art should recognize that the removal of the transferred files could be initiated through the configuration file 325 described above. In this case, another field is added to designate a removal preference variable.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

It should also be emphasized that the above-described embodiments of the present disclosure are merely possible examples of implementations set forth for a clear understanding of the principles of the disclosure. Many variations and modifications may be made to the above-described embodiment(s) of the disclosure without departing substantially from the principles of the disclosure. All such modifications and variations are intended to be included herein within the scope of this disclosure and the present disclosure and protected by the following claims.

1. A file transfer system, comprising:
an originating file transfer host, comprising:
a script server operable to receive a file and a script associated with the file from at least one remote terminal, interpret the script, and transfer the script and the file; and
an originating file transfer server operable to receive the script and the file from the script server and transfer the file to a terminating file transfer server in accordance with the script.

2. The system of claim 1, wherein the originating file transfer server uses a Connect Direct software platform to communicate with a terminating file transfer server.

3. The system of claim 1, wherein the terminating file transfer server is the transfer point from the originating file transfer server to a receiving computer.

4. The system of claim 1, the originating file transfer host further comprising:
a private connection bus operable to transmit information between the script server and the originating file transfer server.

5. The system of claim 1, wherein the script server receives files and scripts from said at least one remote terminal via a Java application programming interface.

6. The system of claim 5, wherein the Java application programming interface is operable to send files and scripts to a particular node of the host.

7. The system of claim 1, wherein the script server is a C language software application on the host system.

8. The system of claim 1, wherein the originating file transfer host is operable to bypass an originating file transfer client associated with the originating file transfer server through using a private connection between the script server and the originating server enabling the host to substantially simultaneously transfer a plurality of files in accordance with a plurality of scripts.

9. The system of claim 8, wherein a transfer process is communicated from the script server to the originating file transfer server via the private connection.

10. The system of claim 1, further comprising:
a terminating file transfer host, comprising:
the terminating file transfer server operable to determine a user identification named in the script and copy the file; and
a home directory associated with the user identification operable to receive the file copy from the terminating file transfer server.

11. The system of claim 10, the terminating file transfer host further comprising:
an agent associated with the home directory, operable to identify a host name and a receive port of a computer associated with the home directory.

12. The system of claim 1 1, wherein the computer associated with the home directory comprises a Java server script operable to monitor for communications on the receive port.

13. The system of claim 12, wherein the agent is operable to remove the file from the home directory after transferring the file to the host name and receive port of the computer associated with the home directory.

14. A method of bulk file transfer, comprising the steps of:
receiving a script and at least one file associated with the script at a script server of a host;
communicating said at least one file to a originating file transfer server of a host; and
transferring said at least one file to a terminating file transfer server in accordance with the script associated with said at least one file.

15. The method of claim 14, wherein the originating file transfer server uses a Connect Direct server to transfer said at least one file in accordance with the script associated with said at least one file.

16. The method of claim 14, wherein the communicating occurs over a private connection between the script server and the originating file transfer server.

17. The method of claim 14, further comprising receiving said at least one file and the script from a remote terminal via a Java application programming interface at the remote terminal.

18. The method of claim 17, wherein the Java application programming interface is operable to send files and scripts to a particular node of the host.

19. The method of claim 14, wherein script server is a C language application on the host.

20. The method of claim 14, further comprising:
using a private connection to bypass an originating file transfer client associated with the originating file transfer server.

21. The method of claim 20, wherein the private connection enables the originating file transfer client to send a plurality of files in accordance with a plurality of scripts substantially simultaneous.

22. The method of claim 21, further comprising communicating a transfer process from the script server to the originating file transfer server via the private connection.

23. The method of claim 14, further comprising:
determining a user identification from the script; and
copying said at least one file to a home directory associated with the user identification.

24. The method of claim 23, further comprising:
using an agent to identify a host name and a receive port at a computer associated with the home directory; and
transferring said at least one file to the host name and the receive port identified by the agent.

25. The method of claim 24, further comprising:
monitoring for communications on the receive port at the computer associated with the home directory.

26. The method of claim 25, further comprising:
removing said at least one file from the home directory after transferring said at least one file to the host name and receive port of the computer associated with the home directory.

27. A computer readable medium having a program for bulk file transfer, the program operable to perform the steps of:
receiving a script and at least one file associated with the script at a script server of a host;
communicating said at least one file to a originating file transfer server of a host; and
transferring said at least one file to a terminating file transfer server in accordance with the script associated with said at least one file.

28. The computer readable medium of claim 27, wherein the originating file transfer server uses a Connect Direct server to transfer said at least one file in accordance with the script associated with said at least one file.

29. The computer readable medium of claim 27, wherein the communicating occurs over a private connection between the script server and the originating file transfer server.

30. The computer readable medium of claim 27, the program further operable to perform the step of receiving said at least one file and the script from a remote terminal via a Java application programming interface at the remote terminal.

31. The computer readable medium of claim 30, wherein the Java application programming interface is operable to send files and scripts to a particular node of the host.

32. The computer readable medium of claim 27, wherein script server is a C language application on the host.

33. The computer readable medium of claim 27, the program further operable to perform the step of:
using a private connection to bypass an originating file transfer client associated with the originating file transfer server.

34. The computer readable medium of claim 33, wherein the private connection enables the originating file transfer client to send a plurality of files in accordance with a plurality of scripts substantially simultaneous.

35. The computer readable medium of claim 34, the program further operable to perform the step of communicating a transfer process from the script server to the originating file transfer server via the private connection.

36. The computer readable medium of claim 27, the program further operable to perform the steps of:
determining a user identification from the script; and
copying said at least one file to a home directory associated with the user identification.

37. The computer readable medium of claim 36, the program further operable to perform the steps of:
using an agent to identify a host name and a receive port at a computer associated with the home directory; and
transferring said at least one file to the host name and the receive port identified by the agent.

38. The computer readable medium of claim 37, the program further operable to perform the step of:
monitoring for communications on the receive port at the computer associated with the home directory.

39. The computer readable medium of claim 38, the program further operable to perform the step of:
removing said at least one file from the home directory after transferring said at least one file to the host name and receive port of the computer associated with the home directory.
